(19) United States
(12) Patent Application Publication
(10) Pub. No.: US 2009/0107616 A1
(43) Pub. Date: Apr. 30, 2009

(54) MANUFACTURING METHOD OF MULTI-LAYER CERAMIC SUBSTRATE

(75) Inventors: Soo Hyun Lyoo, Yongin (KR); Jong Myeon Lee, Gwacheon (KR); Eun Tae Park, Yongin (KR); Hyoung Ho Kim, Suwon (KR)

Correspondence Address: MCDERMOTT WILL & EMERY LLP, 18191 VON KARMAN AVE., SUITE 500, IRVINE, CA, 92612-7108, US

(73) Assignee: SAMSUNG ELECTRO-MECHANICS CO., LTD., Suwon (KR)

(21) Appl. No.: 12/262,104

(22) Filed: Oct. 30, 2008

(30) Foreign Application Priority Data
Oct. 31, 2007 (KR) 10-2007-0110096

(51) Int. Cl. C03B 29/00

(52) U.S. Cl. 156/89.12

(57) ABSTRACT

Provided is a manufacturing method of a multi-layer ceramic substrate. The manufacturing method includes preparing an unsintered ceramic laminated body with a cavity, mounting a chip device within the cavity, filling the cavity, in which the chip device is mounted, with a ceramic slurry, attaching a constrained layer on top and/or bottom of the ceramic laminated body, and firing the ceramic laminated body. Accordingly, since the deformation of the cavity is prevented during the firing of the ceramic laminated body, the dimension precision and reliability of the multi-layer ceramic substrate can be improved.

### CROSS-REFERENCE TO RELATED APPLICATIONS

This application claims the priority of Korean Patent Application No. 2007-110096 filed on Oct. 31, 2007, in the Korean Intellectual Property Office, the disclosure of which is incorporated herein by reference.

### BACKGROUND OF THE INVENTION

1. Field of the Invention

The present invention relates to a manufacturing method of a multi-layer ceramic substrate, and more particularly, to a manufacturing method of a multi-layer ceramic substrate, which mounts a chip device within a cavity formed in a ceramic laminated body, fills the cavity with a ceramic slurry, and fires the ceramic laminated body.

2. Description of the Related Art

Generally, since a multi-layer ceramic substrate using glass-ceramic can implement a three-dimensional interlayer circuit and form a cavity, devices having various functions can be embedded with high design flexibility. Therefore, utilization of multi-layer ceramic substrates is gradually increased in small-sized, multifunctional and high-frequency part markets.

An early multi-layer ceramic substrate has been manufactured by forming an internal circuit pattern and a via on a ceramic green sheet by using a solid paste, laminating and arranging green sheets to a desired thickness according to design, and firing the laminated green sheets. During those processes, a volume of the multi-layer ceramic substrate is shrunk by about 35-50%. In particular, it is difficult to control a lateral shrinkage uniformly, and a dimension error of about 0.5% occurs even within the same order of fabrication as well as different orders of fabrication.

Recently, non-shrinkage methods have been developed which suppress the shrinkage in the lateral direction of the ceramic substrate by using constrained layers. Since the non-shrinkage methods suppress the lateral shrinkage, the dimension precision can be improved.

FIGS. 1A and 1B are vertical cross-sectional views of a related art multi-layer ceramic substrate. Referring to FIG. 1A, a ceramic substrate 1 is formed by laminating a plurality of green sheets 1a, 1b, 1c, 1d and 1e. In this case, a cavity is formed in some of the green sheets in order to embed a chip device 3 into the ceramic substrate 1.

Thereafter, the chip device 3 may be mounted using a solder-flow method which is one of surface mount technologies. Specifically, a solder paste 4 is soldered at a portion of the cavity 3 where the chip device 3 will be mounted. Then, the chip device 3 can be mounted by placing it on the solder paste 4.

After the chip device 3 is embedded into the ceramic substrate 1, constrained layers 5a and 5b are laminated on the top and bottom of the ceramic substrate 1 in order to suppress the lateral shrinkage during the firing process. In this case, the constrained layers 5a and 5b may be formed of an inorganic material which is not shrunk at a firing temperature of the ceramic substrate 1 and of which shrinkage control is easy.

When the constrained layers 5a and 5b are laminated, the ceramic substrate 1 is fired at 700-1,000° C. In this case, during the volume shrinkage of the ceramic substrate 1 by the firing process, the cavity region of the ceramic substrate which is not in contact with the upper constrained layer 5a exhibits non-uniform shrinkage result.

FIG. 1B is a vertical cross-sectional view illustrating the firing result of the multi-layer ceramic substrate of FIGS. 1A and 1B. As described above, it can be seen that non-uniform shrinkage occurs in lateral and longitudinal directions because the constrained layer does not suppress the shrinkage in the cavity region of the ceramic substrate 1. Therefore, the dimension precision of the ceramic substrate 1 is lowered. Furthermore, since the cavity region of the ceramic substrate 1 is shrunk non-uniformly, the chip device 3 mounted within the cavity is separated from the solder paste 4. Consequently, the reliability of the ceramic substrate 1 and the chip device 3 is reduced.

### SUMMARY OF THE INVENTION

An aspect of the present invention provides a manufacturing method of a ceramic substrate, which is capable of improving the reliability of a multi-layer ceramic substrate and a chip device by mounting the chip device within a cavity formed in a ceramic laminated body, filling the cavity with a ceramic slurry, and firing the ceramic laminated body.

According to an aspect of the present invention, there is provided a manufacturing method of a multi-layer ceramic substrate, including: preparing an unsintered ceramic laminated body with a cavity; mounting a chip device within the cavity; filling the cavity, in which the chip device is mounted, with a ceramic slurry; attaching a constrained layer on top and/or bottom of the ceramic laminated body; and firing the ceramic laminated body.

Only a region where the cavity is formed may be filled with the ceramic slurry by using a screen printing method.

The entire surfaces of the ceramic laminated body and the cavity may be filled with the ceramic slurry.

The filling of the cavity with the ceramic slurry may include repeating a process of coating the ceramic slurry on the cavity and drying the coated ceramic slurry.

The ceramic slurry may be formed of inorganic material having a firing temperature within a range of ±100° C. relative to the ceramic laminated body.

The ceramic slurry may be formed of inorganic material having a shrinkage rate within a range of ±10% relative to the ceramic laminated body during the firing process.

The chip device may be a multi-layer ceramic capacitor (MLCC).

The chip device may be a device which is already sintered at a temperature higher than a firing temperature of the ceramic laminated body.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B are vertical cross-sectional views of a related art multi-layer ceramic substrate; and

FIGS. 2A to 2E are vertical cross-sectional views illustrating a manufacturing method of a multi-layer ceramic substrate according to an embodiment of the present invention.

### DETAILED DESCRIPTION OF THE PREFERRED EMBODIMENT

Exemplary embodiments of the present invention will now be described in detail with reference to the accompanying drawings.

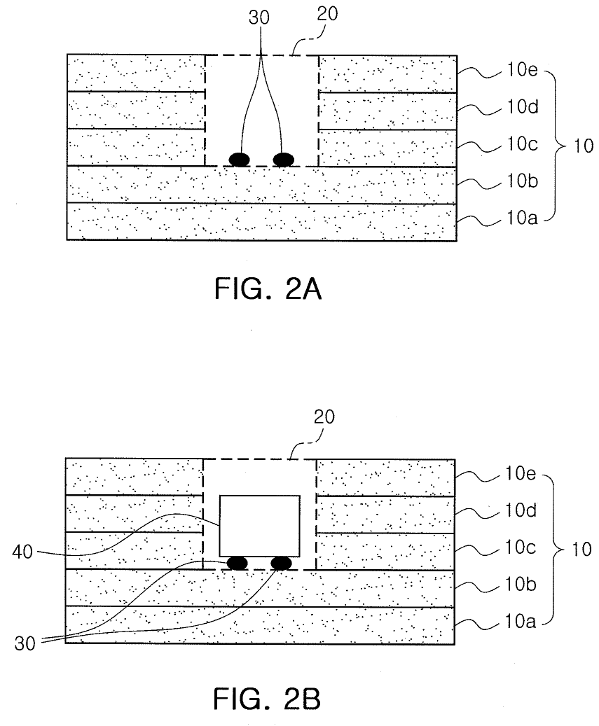

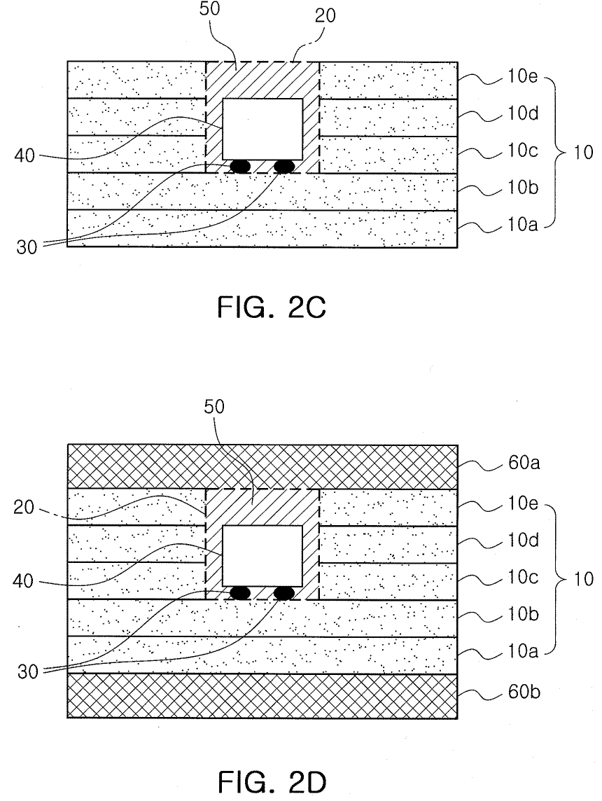

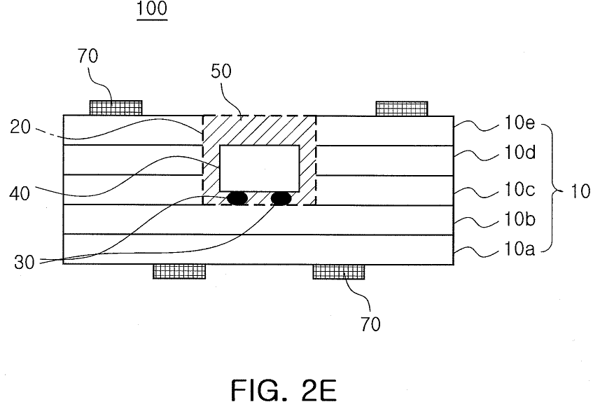

FIGS. 2A to 2E are vertical cross-sectional views illustrating a manufacturing method of a multi-layer ceramic substrate according to an embodiment of the present invention. Referring to FIG. 2A, a ceramic laminated body 10 with a cavity is prepared by laminating a plurality of green sheets 10a, 10b, 10c, 10d and 10e. Specifically, slurry is formed by adding a glass-ceramic powder to an organic binder, a dispersant, and a mixed solvent of toluene and ethanol. The slurry is coated using a doctor blade method, and a 50 μm-thick green sheet is formed. In this way, a plurality of green sheets 10a, 10b, 10c, 10d and 10e are formed. In this case, internal printed patterns may be formed in the green patterns by forming via holes (not shown) and internal electrodes (not shown).

Meanwhile, predetermined positions of some green sheets are punched so that the punched regions form a cavity 20 during the lamination of the green sheets. In FIG. 2A, the cavity 20 is formed by punching the center regions of some green sheets 10c, 10d and 10e and laminating the plurality of green sheets 10a, 10b, 10c, 10d and 10e. Thereafter, a solder paste 30 is soldered in a predetermined region of the cavity 20 of the ceramic laminated body 10 where a chip device will be mounted.

FIG. 2B illustrates a process of embedding a chip device 40 into the ceramic laminated body 10. The chip device 40 is mounted in the predetermined region of the cavity 30 where the solder paste 30 is soldered. In this case, the chip device 40 is a device which has already been fired at temperature higher than the firing temperature of the ceramic laminated body 10. A device which will not be damaged or deformed at the firing temperature of the ceramic laminated body 10 may be used as the chip device 40. A representative example is a multi-layer ceramic capacitor (MLCC) which is formed by laminating ceramic dielectric such as titanium dioxide (TiO₂) or barium titanate (BaTiO₃). The MLCC has good temperature characteristic and its damage or deformation is minimized during the firing process even though it is embedded into the ceramic laminated body 10. Furthermore, in addition to the MLCC, any device may be embedded into the ceramic laminated body 10 if it is not affected by the firing temperature of the ceramic laminated body 10.

FIG. 2C illustrates a process of filling the cavity 20 with a ceramic slurry 50. In this embodiment, the ceramic slurry 50 is shrunk with the ceramic laminated body 10 during the firing process. Therefore, it is suitable that the firing temperature and shrinkage rate of the ceramic slurry 50 are similar or equal to those of the ceramic laminated body 10. Specifically, the firing temperature of the ceramic laminated body 10 is in a range of 700-1,000° C., and the sintering is started within the firing temperature. Therefore, in order for co-firing with the ceramic laminated body 10, the ceramic slurry 50 may be formed of inorganic material having a firing temperature within a range of ±100° C. relative to the ceramic laminated body 10.

In addition, the ceramic slurry 50 may be formed of inorganic material having a shrinkage rate similar or identical to that of the ceramic laminated body 10, and it may be formed to have a viscosity in a range of 100-1,000,000 Cps. The ceramic laminated body 10 may be formed of inorganic material having a shrinkage rate in a range of about 35-50% during the firing process, and the ceramic slurry 50 may be formed of inorganic material having a shrinkage rate of within about ±10% relative to the ceramic laminated body 10.

More specifically, the ceramic slurry 50 may be formed of the same inorganic material as the ceramic laminated body 10, and glass component, organic binder, dispersant and additive may also be formed of the same material as the ceramic laminated body 10. In this case, the ceramic slurry 50 may have the same sintered form as the ceramic laminated body 10 and can minimize the deformation of the cavity 20 during the firing process.

After forming the ceramic slurry 50, the cavity 20 of the ceramic laminated body 10 is filled with the ceramic slurry 50. In this case, the filling of the ceramic slurry 50 may be performed by two embodiments. In one embodiment, as illustrated in FIG. 2C, only the cavity 20 may be filled with the ceramic slurry 50 by arranging a screen in a region except for the cavity 20 in the top surface of the ceramic laminated body 10. In another embodiment, the entire surface of the ceramic laminated body 10 may be filled with the ceramic slurry 50.

Meanwhile, during the process of filling the cavity 20 with the ceramic slurry 50, a predetermined amount of the ceramic slurry is coated while controlling its amount properly, and a drying process is performed. When the ceramic slurry previously coated is dried, a predetermined amount of the ceramic slurry is again coated and then dried. In this way, the cavity 20 can be filled with the ceramic slurry by repeating the process of coating and drying the ceramic slurry. When the cavity 20 is filled with the ceramic slurry 50, the chip device 40 mounted within the cavity 20 is carefully treated not to be exposed to the outside.

FIG. 2D illustrates a process of laminating the constrained layers 60a and 60b in the ceramic laminated body 10. In order to suppress the lateral shrinkage of the ceramic laminated body 10, the constrained layers 60a and 60b are laminated on the top and bottom of the ceramic laminated body 10. In this case, the constrained layers 60a and 60b are attached to the top and bottom of the ceramic slurry 50, so that the shrinkage in the top surface of the ceramic slurry 50 can be suppressed.

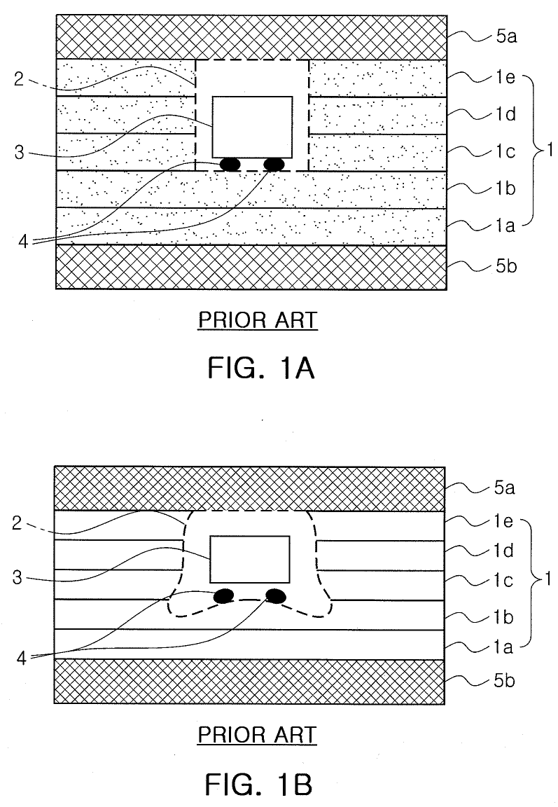

Meanwhile, after the constrained layers 60a and 60b are laminated on the ceramic laminated body 10 and the ceramic slurry 50, the firing process is performed at the firing temperature of the ceramic laminated body 10. In this case, the firing temperature of the ceramic laminated body 10 may be in a range of about 600-1,100° C., more specifically about 700-1,000° C. Due to the firing process, the ceramic laminated body 10 and the ceramic slurry 5 are shrunk in a longitudinal direction. During this process, the ceramic slurry 50 can protect the chip device 40 and prevent the deformation of the cavity 20. That is, as illustrated in FIG. 1B, it is possible to prevent the separation of the chip device 3 from the solder paste 4 and the deformation of the cavity 2. Therefore, the reliability of the ceramic substrate 10 and the chip device 40 can be improved.

In this embodiment, the constrained layers 60a and 60b may be formed of inorganic material which is not shrunk at the firing temperature of the ceramic laminated body 10 and of which shrinkage control is easy. In addition, although not illustrated in FIG. 2D, dummy layers may be further laminated on the top or bottom of the ceramic laminated body 10 before the constrained layers 60a and 60b are laminated. In this case, the dummy layers may be optionally added if necessary.

Referring to FIG. 2E, when the ceramic laminated body 10 is shrunk through the firing process, the constrained layers 60a and 60b are removed. The constrained layers 60a and 60b may be removed using typical technologies such as Buff polishing and sand blast. Thereafter, external electrodes 70 are formed on the top and bottom of the ceramic laminated body 10 by screen printing a conductive paste. In this case, the firing process may be performed for fastening the ceramic laminated body 10 and the external electrodes 70.

In the multi-layer ceramic substrate 100 manufactured in the above-described, the chip device 40 is mounted within the cavity 20 and the cavity 20 is filled with the ceramic slurry 50, so that the chip device 40 is not exposed to the outside. Furthermore, since the chip device 40 and the solder paste 30 are fastened by the ceramic slurry 50, the separation of the chip device 40 can be prevented. Moreover, since the ceramic slurry 50 and the ceramic laminated body 10 are shrunk together in a thickness direction during the firing processing, the deformation of the cavity 20 can be prevented. Consequently, the dimension precision and reliability of the multi-layer ceramic substrate 10 are improved.

According to the embodiments of the present invention, after the chip device is mounted within the cavity formed in the ceramic substrate, the cavity is filled with the ceramic slurry and the ceramic substrate is fired, thereby preventing the ceramic substrate from being deformed by the ceramic slurry during the firing process. Accordingly, it is possible to improve the dimension precision of the ceramic substrate, the mount environment of the chip device mounted within the cavity, and the product reliability.

While the present invention has been shown and described in connection with the exemplary embodiments, it will be apparent to those skilled in the art that modifications and variations can be made without departing from the spirit and scope of the invention as defined by the appended claims.

What is claimed is:

1. A manufacturing method of a multi-layer ceramic substrate, comprising:
preparing an unsintered ceramic laminated body with a cavity;
mounting a chip device within the cavity;
filling the cavity, in which the chip device is mounted, with a ceramic slurry;
attaching a constrained layer on top and/or bottom of the ceramic laminated body; and
firing the ceramic laminated body.

2. The manufacturing method of claim 1, wherein only a region where the cavity is formed is filled with the ceramic slurry by using a screen printing method.

3. The manufacturing method of claim 1, wherein the entire surfaces of the ceramic laminated body and the cavity are filled with the ceramic slurry.

4. The manufacturing method of claim 1, wherein the filling of the cavity with the ceramic slurry comprises repeating a process of coating the ceramic slurry on the cavity and drying the coated ceramic slurry.

5. The manufacturing method of claim 1, wherein the ceramic slurry is formed of inorganic material having a firing temperature within a range of ±100° C. relative to the ceramic laminated body.

6. The manufacturing method of claim 1, wherein the ceramic slurry is formed of inorganic material having a shrinkage rate within a range of ±10% relative to the ceramic laminated body during the firing process.

7. The manufacturing method of claim 1, wherein the chip device comprises a multi-layer ceramic capacitor (MLCC).

8. The manufacturing method of claim 1, wherein the chip device is a device which is already sintered at a temperature higher than a firing temperature of the ceramic laminated body.
